(19) United States
(12) Patent Application Publication
(10) Pub. No.: US 2021/0342904 A1
(43) Pub. Date: Nov. 4, 2021

(54) multi-dimensional system and method for buyers to drive e-commerce

(71) Applicant: Michael Jude Stephan, Caledonia, MI (US)

(72) Inventor: Michael Jude Stephan, Caledonia, MI (US)

(21) Appl. No.: 17/241,089

(22) Filed: Apr. 27, 2021

Related U.S. Application Data
(60) Provisional application No. 63/018,396, filed on Apr. 30, 2020.

(51) Int. Cl. G06Q 30/06; G06Q 30/08; G06Q 10/08; G06Q 20/08; G06Q 30/02; G06F 16/9536

(52) U.S. Cl. CPC G06Q 30/0605; G06Q 30/0633; G06Q 30/0625; G06Q 30/08; G06Q 10/0833; G06Q 10/08345; G06N 20/00; G06Q 20/085; G06Q 10/087; G06Q 30/0201; G06Q 30/0253; G06F 16/9536; G06Q 10/0838

(57) ABSTRACT

The present invention relates to a multi-dimensional system and method for buyer driven e-commerce. Specifically, the present invention provides a system and method to arrange mass materialistic purchases accessing interested goods via standard internet connections. The system provides a unique ecommerce platform that enables buyers to purchase their interested products in a least price. The present system and method can be practiced on wide range of computing arrangements including but not limited to optical or photon computing, quantum computing etc.

### CROSS-REFERENCE TO RELATED APPLICATIONS

For purposes of the USPTO extra-statutory requirements, the present application constitutes a nonprovisional patent application of U.S. provisional patent application Ser. No. 63/018,396, naming Michael Jude Stephan as inventor, filed Apr. 30, 2020.

### FIELD OF THE INVENTION

The present invention relates to a system and method for buyer driven e-commerce. Specifically, the present invention provides a system and method using artificial intelligence-based machine learning algorithms to discover and organize ways to reduce “final consumption expenditure”.

### BACKGROUND OF THE INVENTION

In a traditional business method such as “business-to-consumer,” an online customer can view products on the business web site, choose a product and place an order for the same. However, in comparison with the other buyers, many other buyers are purchasing the same item at the same time without any discount. Organizing any part of online market volume before sales distribution affects mass volume value. Specifically organizing pieces of certain consumer economic data adds value to that data in a half a trillion-dollar market. Nowadays business-to-consumer is old-fashioned as there are few problems addressed with this type of business method such as:
No organized mass discount for consumers buying goods and services equalling bulk or wholesale in a day or on a calendar going into time equalling bulk or wholesale.
No option with the benefits of pre-organization going to consumers.
No option for prepaid organization.
No flexibility to weigh in to lower the price of a purchase on a platform.
No option for auctioning the value of your order.
No collective representative for people buying at once.
No agent present to leverage organized consumer price volume against separated retail price choices.

Another drawback is the lack of any available mass-scale consumer to business retail platform and/or lacking wholesale club for goods and services.

Another problem is with this traditional business method (business to consumer) is that vendors are basically responsible for price-fixing to related goods and services.

In view of the foregoing and other relevant problems, there is a need for a method and system for consumers and service providers to identify each other and gather online as consumer to business independents supporting use and collectively organised and presented, to ensure the most optimum fit for supply of money and demand of services, to promote competitive prices and provide the consumer with a wider range of services and providers with different optional consumer niche fractions to choose.

Therefore, the object of the present invention overcomes the limitations and drawbacks from the prior art. To achieve above and other objects, the present invention anticipates a new and unique business method model that resolves the limitations and drawbacks.

Another object of the present invention is a system and method to monetize consumer-to-business shopping value, which we organize to be our inventory daily. The present invention is a system and method to organize a digital facility and schedule times for suppliers to bargain for the site's inventory that further produces content for auction. The present invention is based on semantic web that enables the encoding of semantics with the data, technologies such as Resource Description Framework (RDF) and Web Ontology Language (OWL) are used. These technologies are used to formally represent metadata. For example, ontology can describe concepts, relationships between entities, and categories of things. These embedded semantics offer significant advantages such as reasoning over data and operating with heterogeneous data sources.

The further object of the present invention is a system and method to use digital organization techniques to advance consumers without the presence of agent presence towards a pre-consumed role with a market representative to correctly align prices with organized mass market trading.

Another object of the present invention is a flexible system and method to produce useful displays based on access to information attained from deposits on pre-arranged transactions this site organizes without a vendor useful meaning the site shows calendars from which clients have self-set fulfillment dates, how many vendors were found offering that Universal Product Coded (UPC) product, i.e. good for competition, what the retail range of price is for that particular UPC, how much deposit the site is holding for auction on that UPC where the deposits are coming from and for what quantity, what UPC search or similar word search activity reveals and continuous seamless diagonal paths shown forming from a consumer-to-business market's expectation. This invention's system and method does create by holding financial commitments for different dates, for separate UPC, combined with displays showing volume of UPC activity, makes for an opaque brokerage platform, a unique way of establishing a free online wholesale club.

The further object of the present invention is a system and method improving vendor, investor and consumer access to simple displays that usually affect informed decisions, but are not available, accessible, accurate, cross-referential, or in real time free to use. When easy to learn displays show where volumes of UPC are heading across time, relative choices appear; select days with volume, days that have lower prices, what days vendors may want to offer better best bids on, days which market investors may find most appealing, different-date markets behave most dynamically, efficiently attracting deeper self-sustaining development toward longer-term benefit. This system and method does improve e-commerce as people interface through the invention to appoint calendar-related dates and releasing monetized consumer interests.

Another object of the present invention is a system and method to project committed monies bundled, opaque, data as a user-friendly superior commercial package; i.e., demand. The macro-economic dashboard with matching calendar illustrates time as a cube and a sphere improving vendors', investors' and consumers' conceptual grasp of this market's multi-dimensionality visibly provided, as it adjusts to factors including real time search activity and soft bids by vendors with interest to place final best bid offers. Additionally, this present invention is a system and method to offer best offers based on search activity of any consumer commitment, a better way to structure pricing to attract and prime commitments into a volume and further create deeper penetrating interests and monetization of consumers interests points.

The further object of the invention is to monetize interest on unannounced goods and services available pending discovery of start-up vendors and established vendors matching expectation. The invention's method presents choice for optimal synergistic exchange. Additionally, it is designed to form aggregate and co-aggregate UPC transfer orders from separately occurring consumer interests within a cycle this system monetizes.

This present invention is a methodical system adding value to products described, and values of product descriptions especially those which are identified by universal product code

The “business-to-consumer” transaction model does not have a broker in place to collectively present consumers' interests or to organize mass-consumer force. The present invention is a system and method to collect and present summary deposits on UPC. Methodically the system presents opaque data useful in determining commercial value set by competitive suppliers. The further object of the invention is a network of consumers identifying their interests in UPC language and valuing their interest with monetizing deposits that re-establishes credit.

The further objects of this invention are market reports based on user-generated content, that being the result of the inventions' system and method co-aggregating money and aggregating value. Another object of the present invention is a system and method to improve conditions for not only the consumer buying the goods or service of interest but also millions if not billions of people also always facing staple needs and household expenditure without end; all benefit.

Another object of the present invention is a system and method for consumers to exercise with a choice. The invention leads to a) e-commerce that systematically is connecting them first to one another, then with products and then the vendors looking for them or, b) e-commerce that is systematically connecting consumers at the last: the vendor comes first, after the vendors' prominence then the products' prominence, then the consumers' interest.

The traditional business method's main aim is to make it easy for shoppers to buy products and enjoy the process of business-to-consumer interaction. This present invention is a system, way and method for consumers to drive with novel reversed polarity: it is a systematic and methodical way to show humans the appraisable value of their wants and needs by providing any vendor a time, way and place to show dollar amounts they will remove from the regular price The further object of the present invention is a system and method of co-aggregating and aggregating consumers committed funds, for specific days, for specific product-by-code transfers versus a warehouse club model that co-aggregates and aggregates goods and services as inventory for transfer to stores; holding inventory for consumers expected to transfer funds as individuals without any committed funds prior to the transfer. The present invention converts any interest in a UPC or identifiable product that was scraped, to inventory with volume to grow in a specified period not more than 24 hours. Each UPC growing volume is a separate product. The invention holds for transfer, consumers' non-refundable deposits equal to the scraped average retail list price. A hold is placed on their payment account.

The further object of the present invention is an automatic system to develop new inventory daily for each UPC, that consumers monetize. The invention co-aggregates or “bundles” for useful valuable inventory monetized interest and volume. Vendors shop the contemporary warehouse essentially for monetized interest the invention has “bundled”.

Another object of the present invention is a system and method for consumers to interface with the multi-dimensional system and method for buyers to drive e-commerce navigation tools; the operating system

The further object of the present invention's business method creates novel “data carriages” which literally are vehicles operators drive in an automated “multi-dimensional control system and method to drive a buyer driven economy” and renders data not methodically assembled by it, useless.

The further object of the present invention is a system and method distributing consumers to businesses. The invention allows businesses to access data quickly on this platform that is changing wants and needs, on this platform. Vendors with great connections which have access to merchandise as quickly as consumers wants or needs shift, are likely to benefit as much from consumers saving on expenditure as much as vendors benefit from steering consumers to save more.

Another object of the present invention is a system and method for people in general, to find partners to vend with or be sponsored by during the transactions contained by the order-arrangements of this invention. This invention presses for novel arrangements between those in a position to finance trade with those that are or wish to be in positions to develop further vending.

The further object of the present invention is a consumer to business platform online for both vendors and consumers to shop together; consumers see products, vendors see consumers looking at products, and consumers see what those vendors are soft bidding to be the supplier.

Another object of the present invention is a system and method to access consumers in order to report the news of what the market is doing, where prices are dropping by rank and category, what investors are doing: soft bidding reports, what new products were scraped, how much was saved the day before, what future orders look like etc.

The further object of the present invention is to establish a platform entirely developed for a consumer-to-business system, driven by consumers within an automated system co-aggregating bundles of their UPC labelled merchandise.

The further object of the present invention is to methodically simulate auctions of real market data. The result and purpose of these false auctions is to immerse consumers in real data streaming through the market and lives of other people who are visiting, shopping, selling, and finding investments at that time. The present invention is a system and method to improve knowledge before going to market for shopping or other various reasons such as to learn about: products, orders on calendars, products orbiting other products, volumes growing, possible relationships between volumes growing with volumes leveling off, merchandise additions, other time cycles, inventory, soft bid price-to-MSRP of an item or the market at large, to see the ratio of vendors-to-searches.

Another object of the present invention methodically informs people of market conditions to familiarize them with helpful consumer information adding confidence to an instinctive society that it's hearing what is real like the weather report. This is similar to a news channel of buying, a platform as an aggregator for market fact content and a system to create a 10-day price forecast.

Another object of the present invention is a system for people to automatically access calendars to choose when they want fulfillment knowing what suits their interest best.

The further object of the present invention is an established National UPC-topic forum focusing on efficiency.

Further objects of the present invention: a) to commercially channel and host cultural consumer to business “shows” accessing real time and “beyond real time” data, b) to universally lead visitors through a theatrical spectrum of programs and plug-in applications. latticed together, and c) to positively influence volumes of monetized deposits.

The further object as a present invention is to wholly contain, delegate and access any arrangement for perpetual consumers' surplus, organizing matters of spending for best consumer price protection. Consumers in general are not choosing not to versus driving matters to present themselves, they simply do not have choice without this invention's system and method. This invention is a system and method to strike deals with vendors and investors for consumers' surplus.

The further object of the invention is an operating system for consumers to use as “shopping cart” in a day, without the traditional cost associated with paying as an individual or as a consumer separated from other consumers. It seems online a convenience charge is applied to orders for coming in separately, without the actual option being selected, to come in separately. Traditional platform options don't include a way to shop co-aggregated and counted as merchandise in an all-in-one a shopping cart auction process. The operating system as a shopping cart gives access for many to spend online with orders to fabricate from Individual household orders virtual wholesale pallets to be auctioned for the dollar amount of Interest deposited on virtually any UPC labelled item.

The further object of the present invention is closed organized final best bid auctions for consumers' deposits with auction entrance set at or above a minimum saved amount set by the present invention.

The further object to the present invention is closed organized final best-bid auctions for processing consumer deposits as products with revenue-gross-value.

The further object of the present invention is to perform reverse auctions with accumulating data from this platform of scraped data being searched. The platform further shows these real time searches in a volume format, pairs it with scraped vendors content and runs positively false-reverse auctions, advertising the false reverse auction data (based on searches) to stimulate real data conversion to monetized actions.

The automatic bundling system for business is adaptable to any kind of business and is not limited to any specific type of business.

### SUMMARY OF THE INVENTION

In an embodiment the disclosed system and method is useful to sell and buy brokered volume and process organised spending on a scale of mass proportion above what people can do in their own way for their own living such as saving coupons and buying bulk. In another embodiment, possession allows organising consumers spending that further enables organised spending to identify the best vendor that provides the lowest price. In another embodiment the system categorizes spending as an event happening every day that needs an event organizer.

In an other embodiment, the disclosed system and method establishes an online warehouse club that enables users or consumers to realize the entire market place or e-commerce is up for best bid each day. Similarly, the present system only works with vetted vendors and the lowest price is set by competition and not vendors; this makes more time for shopping. In addition, the present system is ideally suited for people that make their own decisions and appointments and are highly organized and proactive and group oriented and into efficiency and saving money in general and working for a new way to buy whether they care about saving money or not using it to show support and using it helps lower the price for other people.

Content is scraped for real-time use. Single UPC can be used in unlimited configurations of data while maintaining the Integrity of a system to lower prices. Once content is scraped from the data people in real time then search those products and they get organized autonomously into bundles.

Further, at the end of a 24-hour cycle (12 am to 12:30 am), an auction occurs for half an hour in which the best bid of all various sum occurs or any less portion of Essentially, a purchasing agent acts on behalf of consumers in a similar way as a single large corporation needing a variety of products in volume and making a prepayment.

Subsequently, suppliers (selling businesses) visit the platform to shop for large bundles of consumers that are well organized and prepaid. For example, it is similar in a way that consumers going to a wholesale market and looking for bulk merchandise with a lower price.

In an other embodiment, macro bundles, macro orders, macro carts includes simultaneously shopping for the same item during the same day, that may not have to be separated by the traditional business to consumer practice where each seller have their own separate cashier.

Further the application of the present invention allows users to eliminate millions of separated transactions for greater efficient spending. Specifically, multiple orders are bundled in one shopping cart each day so that the bundle of orders can get a best price from a reputable seller who can further fulfill the orders at reduced prices. In addition, the present system directs all the virtual carts into one virtual cart are actually processed by artificial intelligence to separate all the UPC within a generic cart.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other aspects, and advantages of the subject matter described herein will become apparent from the following detailed description, and claims.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 provides a flow visualization of the multi-dimensional system and method of buyer driven e-commerce.

FIG. 2 provides a funnel visualization of different levels of multi-dimensional system and method of buyer driven e-commerce.

FIG. 3 provides a timeline visualization of the process of the multi-dimensional system and method of buyer driven e-commerce.

### DETAILED DESCRIPTION OF PREFERRED EMBODIMENT(S)

The following detailed description is intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

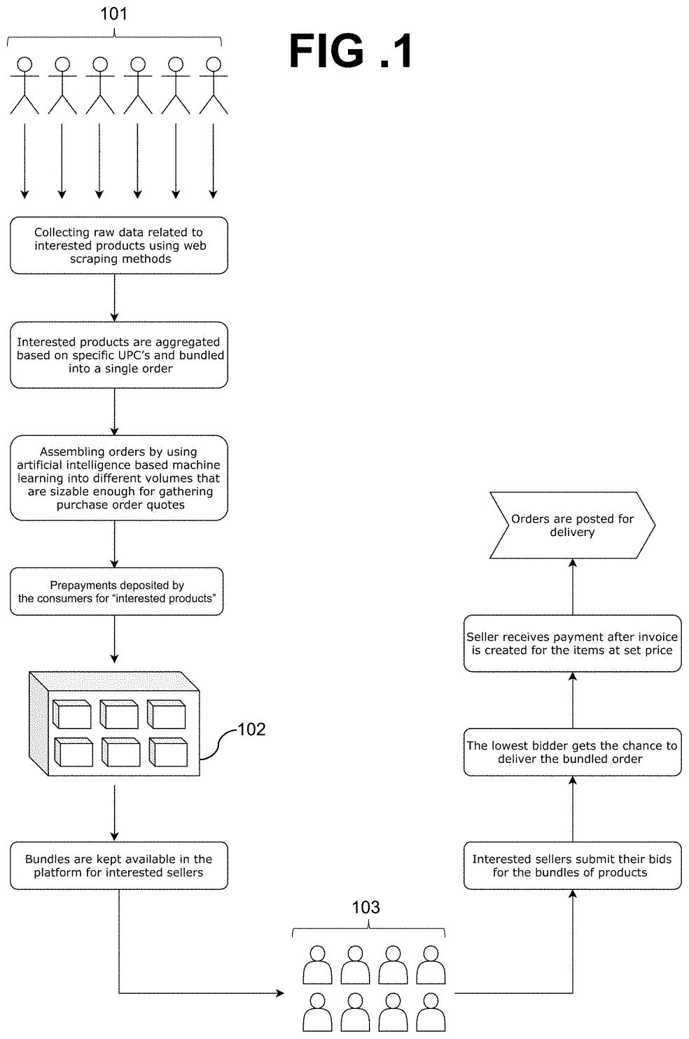

Referring to FIG. 1, the present multi-dimensional system and business method provides a wholesale or warehouse club platform that is entirely for consumer to business agreements which is driven by aggregated bundles of UPC labelled merchandise.

The initial step of the system operates by collecting the raw data that identifies the regular shopping and searching activity of the shoppers 101 and the products they are interested in purchasing. This step of extraction of raw data can be correlated to buyer focused web scraping and can be performed manually or by using artificial intelligence-based machine learning systems.

Once the raw data of the “interested products” has been searched and scraped, the interested products are aggregated based on specific UPC's and bundled into a single order 102. In this scenario, the consumers 101 have a raw element quality such as commodities, at its most basic level known as “interested products”.

In the next step, the system bundles online “interested products” as consumables, identified by UPC. The scope of the system is not limited to UPC scans, voice input or recognition and navigation other than by sight and screen touch or key strokes for placing orders and bidding.

Additionally, the system also detects eye motion and wide view imagery for object detection, then matches image with scraped UPC.

In the next step, the platform assembles orders by using artificial intelligence based machine learning into different volumes that are sizeable enough for gathering purchase orders. The system enables users 101 to be represented under a purchasing agent that is acting on behalf of all the consumers as if they were a single large corporation needing a variety of products in volume. The prepayments deposited by the consumers 101 for “interested products” are released within 24 hours.

In the next step, suppliers 103 (selling businesses) go to the platform to shop for large bundles of consumers 102 that are well organized and prepaid. For example, it is similar in a way that consumers going to a wholesale market and looking for bulk merchandise with a lower price. Vendors pay a fair transaction fee to proprietary controller for the bundles. Vendors gain residual sale opportunities, advantage over competitors and additional market exposure.

Once the interested sellers 103 have submitted their bids for the bundles of products, the lowest bidder gets the chance to deliver the bundled order and receives payment after invoice is created for the items at set price. In the next step, the orders are posted for delivery and both shopper and broker receive the formal tracking number.

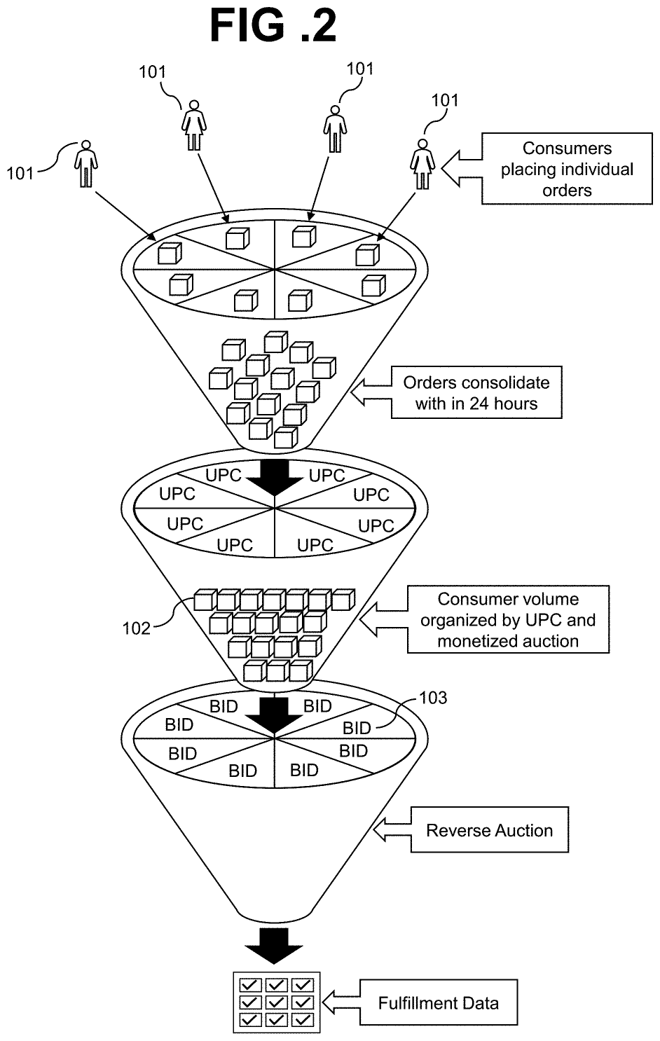

Referring to FIG. 2, the same embodiment of the present invention provides different levels of the multi-dimensional system and method of buyer driven e-commerce. In the initial stage of the multi-dimensional system and method, the consumers 101 place orders 102 individually and the orders 102 are consolidated in every 24 hours. In the next stage the orders 102 are organized and bundled according to the UPC and the bundles are kept available for auction. Further, the interested vendors 103 place their bids where the lowest bidder 103 wins the chance to fulfill the order. Finally, the fulfillment data is consolidated and can be further tracked.

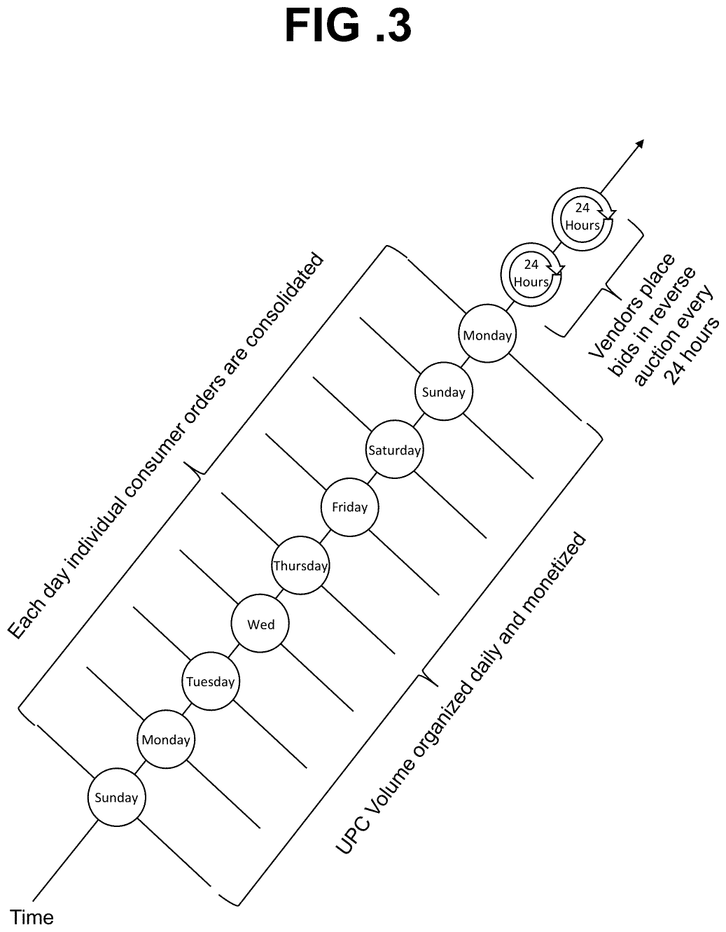

Referring to FIG. 3, one embodiment of the present invention provides a timeline visualization of the process of the multi-dimensional system and method of buyer driven e-commerce. The system UPC codes within commerce are automatically organized for spending efficiency. This platform challenges vendors to become more efficient due to auctions organizing competitions for vendor-business volume. This lowers margins and to combat lower margins, vendor's business activity must become more efficient to offset margin-discounting.

In another embodiment of the present invention, the platform eliminates millions of separated transactions for greater efficient spending. Specifically, multiple orders are bundled in one shopping cart each day so that the bundle of orders can get a best price from a reputable seller who can further fulfill the orders at reduced prices.

In a preferred embodiment of the disclosed method/system, provides a way for consumers to drive with novel reversed polarity: it is a systematic and methodical way to show consumers the appraisable value of their requirements by providing any vendor a time, way and place to show value amounts they will remove from the regular price.

Another embodiment of the disclosed invention provides co-aggregating and aggregating consumers' committed funds, for specific days, for specific product-by-code transfers versus a warehouse club model that co-aggregates and aggregates goods and services as inventory for transfer to stores; holding inventory for consumers expected to transfer funds as individuals without any committed funds prior to the transfer. The present invention converts any interest in a UPC or identifiable product that was scraped, to inventory with volume to grow in a specified period not more than 24 hours each UPC growing volume is a separate product. The invention holds for transfer, consumers' non-refundable deposits equal to the scraped average retail list price. A hold is placed on their payment account.

Another embodiment of the present invention is an automatic system to develop new inventory daily for each UPC, that consumers monetize. The invention co-aggregates or “bundles” for useful valuable inventory monetized interest and volume. Vendors shop the contemporary warehouse essentially for monetized interest the invention has “bundled”.

Another embodiment of the present invention is a system and method for consumers to interface with the multi-dimensional system and method for buyers to drive e-commerce navigation tools; the operating system.

In another embodiment, the disclosed system/method creates novel “data carriages” which literally are vehicles operators drive in an automated “multi-dimensional control system and method to drive a buyer driven economy” and renders data not methodically assembled by it, useless.

The disclosed system/method allows businesses to access data quickly on this platform that is changing wants and needs, on this platform. Vendors with great connections which have access to merchandise as quickly as consumers wants or needs shift, are likely to benefit as much from consumers saving on expenditure as much as vendors benefit from steering consumers to save more.

Another embodiment of the present invention is a system and method for people in general to find business partners to offer the interested products and be sponsored during the transactions contained by the order-arrangements of this invention. This invention presses for novel arrangements between those in a position to finance trade with those that are or wish to be in positions to develop further vending.

Another embodiment of the present invention is a consumer to business platform online for both vendors and consumers to shop together in real-time; consumers see products, vendors see consumers looking at products, and consumers see what those vendors are bidding so as to be the supplier.

In preferred embodiments of the present disclosure, the system and method provide access to consumers in order to report the news of what the market is doing, where prices are dropping by rank and category, what investors are doing: soft bidding reports, what new products were scraped, how much was saved the day before, what future orders look like etc. The disclosed method is applicable to establish a platform entirely developed for a consumer-to-business system, driven by consumers within an automated system co-aggregating bundles of their UPC labelled merchandise; expenditure interest.

In another embodiment, the system and method simulate false auctions of real market data. The result and purpose of these false auctions is to immerse consumers in real data streaming through the market and activity of other consumers who are visiting, shopping, selling and finding investments in real-time. The present invention is a system and method to improve the market knowledge of consumers before going to market for shopping or other various reasons such as to learn about: products, orders on calendars, products orbiting other products, volumes growing, possible relationships between volumes growing with volumes levelling off, merchandise additions, other time cycles, inventory, soft bid price-to-MSRP of an item or the market at large, to see the ratio of vendors-to-searches.

In another embodiment the disclosed method informs people of market conditions to familiarize them with helpful consumer information adding confidence to instinctive society that uses tools and will drive the consumer to business e-commerce marketplace to places other systems' designs simply weren't intended to go to.

In another embodiment, the disclosed system enables people to automatically access calendars to choose when they want fulfillment knowing what suits their interest best.

In another embodiment, the disclosed system provides a National UPC-topic forum focusing on efficiency.

In preferred embodiments of the present disclosure, the system is operative with the program to: a) commercially channel and host cultural consumer to business “shows” accessing real time and “beyond real time” data; b) universally lead visitors through a theatrical spectrum of programs and plug-in applications latticed together; and c) positively influence volumes of monetized deposits.

In another embodiment, the disclosed system/method provides access to any arrangement for perpetual consumers' surplus expenditure interest, organizing matters of spending for best consumer-price protection wherein consumers in general are not driving matters to present themselves, the consumers do not have choice without this invention's system and method. This invention is a system and method to strike deals with vendors and investors for consumers' surplus.

In another embodiment, the disclosed system can be used as an operating system for consumers to use as a “shopping cart” in a day, without the traditional cost associated with paying as an individual or as a consumer separated from other consumers. It seems online a convenience charge is applied to orders for coming in separately, without the actual option being selected, to come in separately. Traditional platform options don't include a way to shop co-aggregated and counted as merchandise in an all-in-one a shopping cart auction process. The operating system as a shopping cart gives access for many to spend online with others to fabricate from individual household orders wholesale pallets to be auctioned for the dollar amount of interest deposited on virtually any UPC labelled item.

In another embodiment, the disclosed system/method is closed, organized final best bid auctions for consumer deposits above 30% retail price reduction. Further the system/method closed, organized final best bid auctions for consumer deposits as products with revenue-gross-value not less than retail value multiplied by 50 units.

In another embodiment, the present invention system/method enables sellers to perform reverse auctions with accumulating data from this platform of scraped data being searched. The platform further shows these real time searches in a volume format, pairs it with scraped vendors content and runs positively false-reverse auctions, advertising the false reverse auction data (based on searches) to stimulate real data conversion to monetized actions. The automatic bundling system for business is adaptable to any kind of business and is not limited to any specific type of business.

In another embodiment, the present invention system/method could be practiced using quantum-mechanical phenomena such as superposition and entanglement to perform computation, which is also known as quantum computing.

In a further embodiment, the present invention system/method could be practiced using photons produced by lasers or diodes to perform computation, which is also known as optical computing or photon computing.

In another embodiment, the present invention system/method could be practiced through a virtually simulated environment that can be similar to or completely different from the real world.

Although the description above contains many specifics, these should not be construed as limiting the scope of the embodiments but as merely providing illustrations of some of several embodiments.

1. A method for buyer driven e-commerce, the method comprising steps of:
providing a platform that enables consumers to place orders for interested products;
collecting the raw data that identifies the regular shopping and searching activity of the consumers and the products they are interested in purchasing;
aggregating consumers' interests in products based on UPC's in every 24 hours and bundling them into a single order;
assembling the orders into different volumes that are sizeable enough for gathering purchase order quotes;
enabling suppliers or selling businesses to bid on bundles of products and awarding the order to the seller with the lowest bid to deliver the bundled order;
providing the tracking details of the product to the consumer and the seller to enable both parties to track the product in real-time; and
confirming the receipt of products delivered by the seller and processing the payment to the seller once the requested products are delivered and are in appropriate manner.

2. The method of claim 1, in which the step of extraction of raw data is correlated to buyer focused web scraping and is performed manually or by using artificial intelligence-based machine learning systems.

3. The method of claim 1, in which the step of bundling the orders is performed by an automatic system that develops an inventory every 24 hours for each UPC.

4. The method of claim 1, wherein multiple orders are bundled in one shopping cart each day so that the bundle of orders can get a best price from a reputable seller who can further fulfill the orders at reduced prices.

5. A system for facilitating a transaction between at least one of a plurality of consumers and at least one of a plurality of sellers, comprising:
a storage device; and
a processor connected to the storage device, wherein the storage device storing a program for controlling the processor; and the processor operative with the program to:
enable consumers to place orders for interested products;
collect the raw data that identifies the regular shopping and searching activity of the consumers and the products they have an interest in, to purchase;
aggregate the consumer interested products based on UPC's in every 24 hours and bundle them into a single order;
assemble the orders into different volumes that are sizeable enough to gather purchase orders;
enable suppliers or selling businesses to bid on bundles of products and award the order to the seller with the lowest bid to deliver the bundled order;
provide the tracking details of the product to the consumer and the seller to enable both parties to track the product in real-time; and
confirm the receipt of products delivered by the seller and process the payment to the seller once the requested products are delivered and are in appropriate manner.

6. The system of claim 5, in which the processor is further operative with the program to: extract the raw data and correlate to buyer focused web scraping which performed manually or by using artificial intelligence-based machine learning systems.

7. The system of claim 5, in which the processor is further operative with the program to:
co-aggregate and aggregate consumers committed funds, for specific days, for specific product-by-code transfers versus a warehouse club model that co-aggregates and aggregates goods and services as inventory for transfer to stores; holding inventory for consumers expected to transfer funds as individuals without any committed funds prior to the transfer.

8. The system of claim 5, in which the processor is further operative with the program to develop new inventory daily for each UPC, that consumers monetize.

9. The system of claim 5, in which the processor is further operative with the program to enable sellers to find business partners to offer the interested products and be sponsored during the transactions contained by the order-arrangements.

10. The system of claim 5, in which the processor is further operative with the program to provide a platform that enables sellers and consumers to shop together in real-time wherein the consumers see the products and the sellers can see the consumers seeing the products, and consumers see the biddings made by interested sellers.

11. The system of claim 5, in which the processor is further operative with the program to simulate false auctions of real market data wherein the purpose of the false auctions is to immerse consumers in real data streaming through the market and activity of other consumers who are visiting, shopping, selling and finding investments in real-time.

12. The system of claim 5, in which the processor is further operative with the program to improve the market knowledge of consumers before going to market for shopping or other various reasons such as to learn about: products, orders on calendars, products orbiting other products, volumes growing, possible relationships between volumes growing with volumes levelling off, merchandise additions, other time cycles, inventory, soft bid price-to-MSRP of an item or the market at large, to see the ratio of vendors-to-searches.

13. The system of claim 5, in which the processor is further operative with the program to provide a national UPC-topic forum focusing on efficiency.

14. The system of claim 5, in which the processor is further operative with the program to:
commercially channel and host cultural consumer to business “shows” accessing real time and “beyond real time” data;
universally lead visitors through a theatrical spectrum of programs and plug-in applications latticed together; and
positively influence volumes of monetized deposits.

15. The system of claim 5, in which the processor is further operative with the program to delegate and access any arrangement for perpetual consumers' surplus, organizing matters of spending for best consumer-price protection.

16. The system of claim 5, in which the processor is further operative with the program to close and organize final best bid auctions for consumer deposits above 30% retail price reduction and further close and organize final best bid auctions for consumer deposits as products with revenue-gross-value not less than retail value multiplied by 50 units.

17. The system of claim 5, in which the processor is further operative with the program to:
perform reverse auctions with accumulating data from this platform of scraped data being searched;
show the real time searches in a volume format, pairs it with scraped vendors content and runs positively false-reverse auctions, advertising the false reverse auction data based on searches to stimulate real data conversion to monetized actions.

18. The system of claim 5, wherein multiple orders are bundled in one shopping cart each day so that the bundle of orders can get a best price from a reputable seller who can further fulfill the orders at reduced prices.

19. The system of claim 5, wherein any interest in a UPC identifiable product that was scraped to inventory with volume to grow in a specified period for at least 24 hours, wherein each UPC growing volume is a separate product.

20. The system of claim 5, wherein the sellers that have access to interested products as quickly as consumers wants or needs shift, are likely to benefit from consumers saving on expenditure and vendors benefit from steering consumers to save money.
